(19) United States
(12) Patent Application Publication
(10) Pub. No.: US 2014/0308847 A1
(43) Pub. Date: Oct. 16, 2014

(54) BRAID FIXTURE

(71) Applicant: Yazaki Corporation, Minato-ku, Tokyo (JP)

(72) Inventors: Masahiro Tanaka, Kakegawa-shi (JP); Hajime Kato, Kakegawa-shi (JP)

(73) Assignee: YAZAKI CORPORATION, Minato-ku, Tokyo (JP)

(21) Appl. No.: 14/356,956

(22) PCT Filed: Nov. 22, 2012
(86) PCT No.: PCT/JP2012/081009

§ 371 Date: May 8, 2014

(30) Foreign Application Priority Data
Nov. 24, 2011 (KP) 2011-256467

(51) Int. Cl. H01R 13/6592

(52) U.S. Cl. CPC H01R 13/6592
USPC 439/607.41

(57) ABSTRACT

A braid fixture clamps an end portion of a braid, which covers an outer circumference of a cylindrical portion of a shield shell, onto the shield shell. The braid fixture includes a pair of fixing pieces that is formed in a band shape capable of surrounding the outer circumference of the cylindrical portion of the shield shell with the braid which is formed on the outer circumference of the cylindrical portion. A male portion and a female portion are configured to be engaged with and disengaged from each other, and are provided on one end portions of the pair of fixing pieces respectively. Flanges are configured to be fastened by a screw, and are provided on the other end portions of the pair of fixing pieces.

### TECHNICAL FIELD

The present disclosure relates to a braid fixture for clamping an end portion of a braid which covers a cylindrical portion of a shield shell, onto the shield shell.

### BACKGROUND ART

PTL (Patent Literature) 1 discloses a braid fixing structure using a braid fixture according to the related art, and FIG. 5 shows the braid fixing structure.

In FIG. 5, reference numeral 301 represents a shielded connector which has terminals (not shown), a connector housing 302 that is made of a resin and accommodates the terminals, and a metal shield shell 303 that covers the outer side of the connector housing 302. For connecting an end portion 306a of a braid 306 to the shield shell 303 of the shielded connector 301, a band-shaped metal fixture 310 is used.

The fixture 310 has an annular band 311 capable of surrounding the end portion 306a of the braid 306 and covering the outer circumference of a cylindrical portion 304 of the shield shell 303, and flanges 315, 316 are provided to both ends of a separation portion provided at one part of the annular band 311 in the circumferential direction and can be fastened by a screw.

When the fixture 310 is used, the outer circumference of the cylindrical portion 304 of the shield shell 303 is covered with the end portion 306a of the braid 306. Next, the end portion 306a of the braid 306 is covered with the annular band 311 of the fixture 310 while the gap between the flanges 315, 316 provided at both ends of the separation portion is slightly widened, whereby the end portion 306a of the braid 306 is interposed between the annular band 311 and the cylindrical portion 304 of the shield shell 303. In this state, the tip of a bolt 317 is passed through through-holes 315a, 316a of the two flanges 315, 316, and a nut is tightened onto the tip of the bolt 317, whereby the end portion 306a of the braid 306 is clamped onto the outer circumference of the cylindrical portion 304 of the shield shell 303 by the fixture 310.

### CITATION LIST

Patent Literature

[PTL 1] JP-A-2005-339933

### SUMMARY OF INVENTION

### Technical Problem

However, it is necessary to assembly the fixture 310 with the cylindrical portion 304 of the shield shell 303 while slightly widening the gap between the flanges 315, 316 so as to deform the annular band 311. Due to the deformation of the annular band 311, clamping with respect to the braid 306 becomes insufficient.

The present disclosure was made in view of the above-mentioned circumferences, and an object of the present disclosure is to provide a braid fixture capable of simply clamping a braid onto a shield shell by a sufficient force, without increasing the number of bolts and nuts and a man-hour for clamping.

### Solution to Problem

The above-mentioned object of the present disclosure is achieved by the following configurations.

There is provided a braid fixture for clamping an end portion of a braid, which covers an outer circumference of a cylindrical portion of a shield shell, onto the shield shell, the braid fixture comprising:

a pair of fixing pieces that is formed in a band shape capable of surrounding the outer circumference of the cylindrical portion of the shield shell with the braid which is formed on the outer circumference of the cylindrical portion,

wherein a male portion and a female portion are configured to be engaged with and disengaged from each other, and are provided on one end portions of the pair of fixing pieces respectively; and

wherein flanges are configured to be fastened by a screw, and are provided on the other end portions of the pair of fixing pieces.

For example, the fixing pieces have substantially same shape to each other without the male portion and the female portion.

According to the above configuration, the fixing pieces are matched with each other while the male portion and the female portion provided at the one end portions of the fixing pieces are engaged with each other. Therefore, it is possible to interpose the end portion of the braid between the fixing pieces and the shield shell, without entirely deforming the both fixing pieces. Further, in that state, the flanges provided at the other end portions of the pair of fixing pieces are matched with each other, and the flanges are fastened by the screw. Therefore, it is possible to clamp the end portion of the braid onto the cylindrical portion of the shield shell.

In this case, since each of the pair of fixing pieces is half of the fixture, during assembling, it is unnecessary to deform anything. Therefore, a clamping force is prevented from being damaged due to deformation of the fixing pieces, and thus it is possible to clamp the braid by a sufficient force. Also, since the assembling is completed by fastening one position by the screw, it is possible to simply connect the braid to the shield shell with a sufficient clamping force without increasing not only the number of bolts and nuts but also a man-hour for clamping.

For example, the braid fixture further comprises:

a pair of other fixing pieces that is formed in a band shape capable of surrounding an outer circumference of a cylindrical portion of other shield shell with a braid which is formed on the outer circumference of the cylindrical portion of the other shield shell,

wherein other male portion and other female portion are configured to be engaged with and disengaged from each other, and are provided on one end portions of the pair of the other fixing pieces respectively;

wherein the other end portions of the pair of the other fixing pieces are connected to the flanges of the fixing pieces respectively; and

wherein the pair of the other fixing pieces clamps an end portion of the braid, which covers the outer circumference of the cylindrical portion of the other shield shell, onto the shield shell.

For example, the other fixing pieces have substantially same shape to each other without the other male portion and the other female portion.

According to the above configuration, the pair of other fixing pieces are matched with each other while the other male portion and the other female portion provided at the one end portions are engaged. Therefore, it is possible to interpose the end portion of each braid between the fixing pieces and a corresponding shield shell without entirely deforming the both fixing pieces. Further, in that state, the flanges of the intermediate portions of the fixing pieces are matched with each other, and are fastened by the screw. Therefore, it is possible to simultaneously clamp the end portions of a plurality of braids onto the corresponding cylindrical portions of the shield shells, respectively.

In this case, since each of the pair of fixing pieces is half of the fixture, during assembling, it is unnecessary to deform anything. Therefore, a clamping force is prevented from being damaged due to deformation of the fixing pieces, and thus it is possible to clamp the braid by a sufficient force. Also, since the assembling is completed by fastening one position by the screw, it is possible to simply connect the braids to the shield shells with a sufficient clamping force, respectively, at the same time, without increasing not only the number of bolts and nuts but also a man-hour for clamping.

### Advantageous Effects of Invention

According to the present disclosure, it is possible to simply clamp a braid onto a shield shell by a sufficient force, without increasing the number of bolts and nuts and a man-hour for clamping.

### BRIEF DESCRIPTION OF DRAWINGS

FIGS. 1A to 1C are views illustrating the configuration of a fixture according to a first embodiment of the present disclosure. More specifically, FIG. 1A is a perspective view illustrating a pair of fixing pieces constituting the fixture, FIG. 1B is a perspective view illustrating a state where a male portion and a female portion provided at ends of the pair of fixing pieces on one side are engaged with each other, and FIG. 1C is a perspective view illustrating a state where flanges provided at ends of the pair of fixing pieces on the other side are matched with each other and are fastened by a screw.

FIG. 2 is an exploded perspective view illustrating a case of using the fixture of the first embodiment to fix an end portion of a braid to a cylindrical portion of a shield shell of a shielded connector.

FIGS. 3A to 3C are views illustrating the configuration of a double-barreled fixture according to a second embodiment of the present disclosure. More specifically, FIG. 3A is a perspective view illustrating a pair of fixing pieces constituting the fixture, FIG. 3B is a perspective view illustrating a state where male portions and female portions of the pair of fixing pieces on both sides are engaged, and FIG. 3C is a perspective view illustrating a state where flanges of intermediate portions of the pair of fixing pieces are matched with each other and are fastened by a screw.

FIG. 4A is a perspective view illustrating a configuration in a case where the fixture of the second embodiment is used to fix end portions of two braids to two cylindrical portions of a shield shell of a shielded connector, and FIG. 4B is a view illustrating the configuration of FIG. 4A as seen in the direction of an arrow IVB.

FIG. 5 is an exploded perspective view illustrating a case of using a fixture according to the related art to fix an end portion of a braid to a cylindrical portion of a shield shell of a shielded connector.

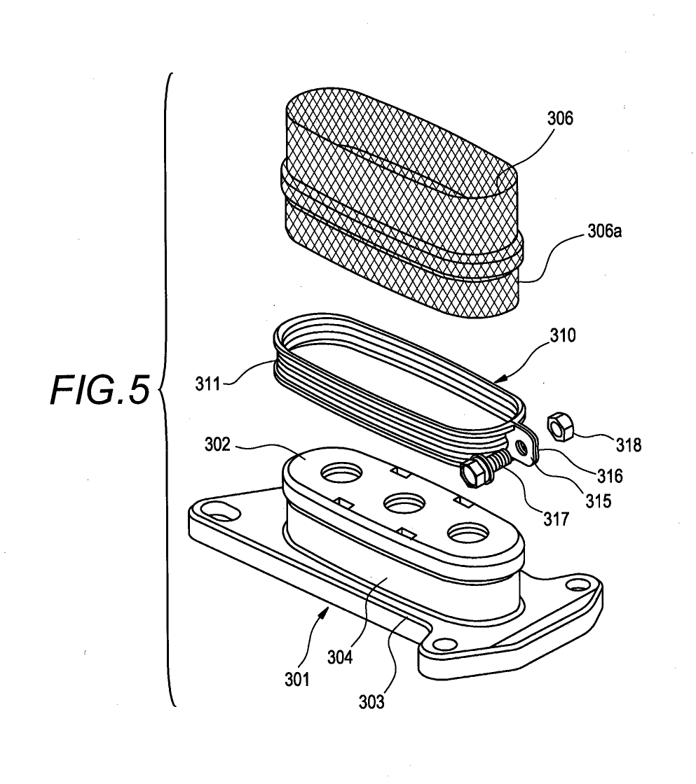

### DESCRIPTION OF EMBODIMENTS

Hereinafter, embodiments of the present disclosure will be described with reference to the accompanying drawings.

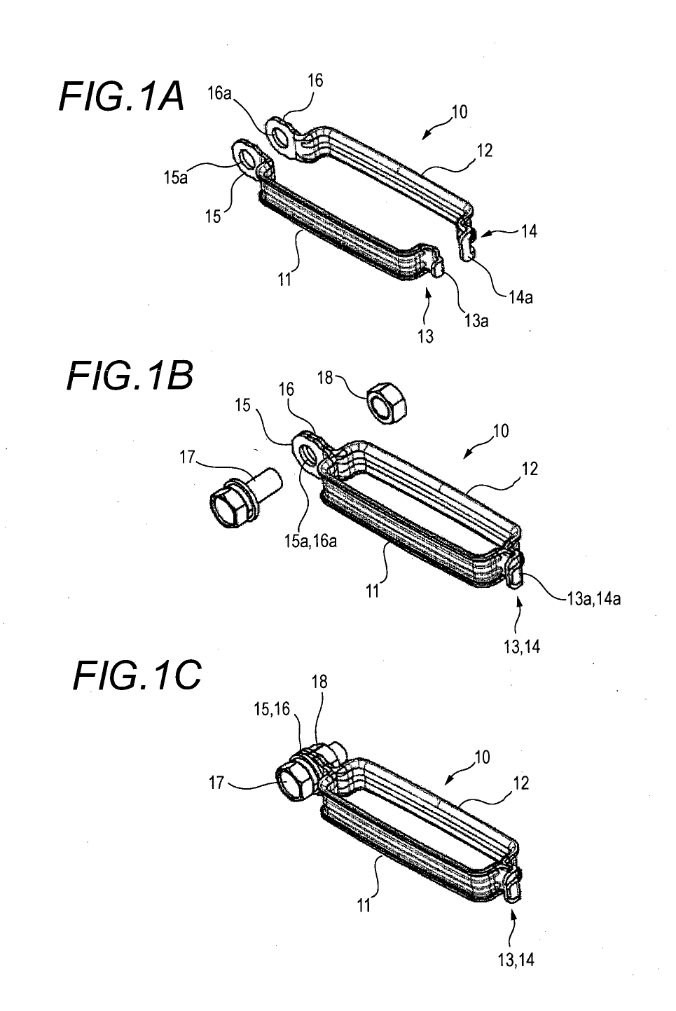

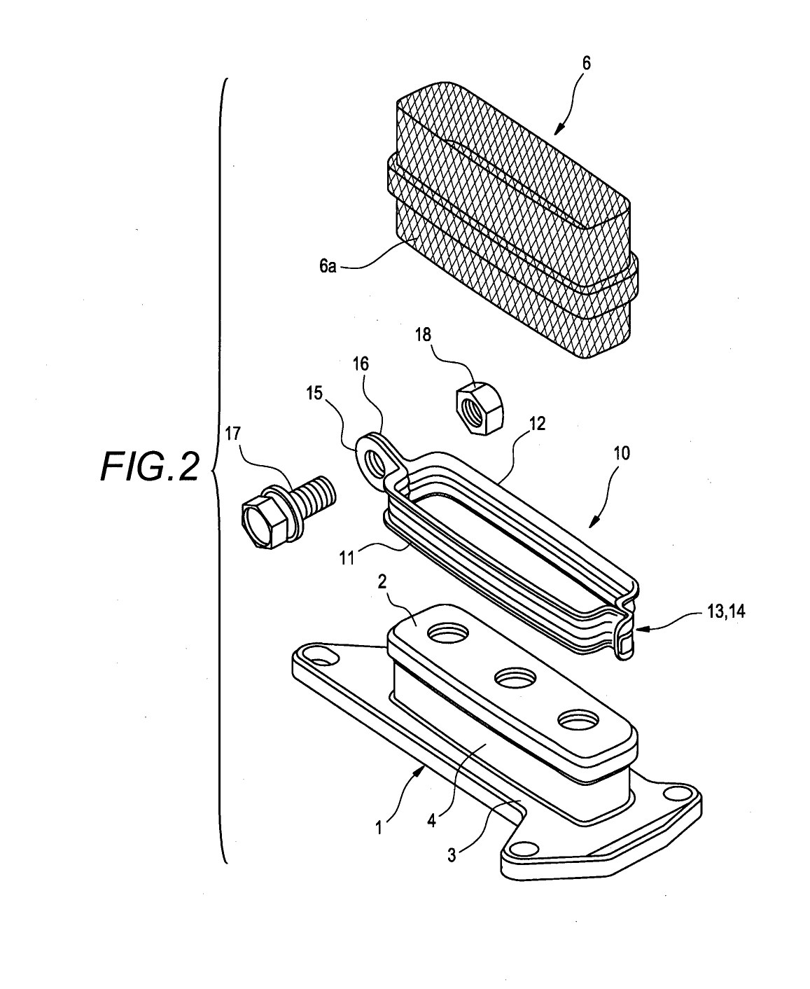

FIGS. 1A to 1C are views illustrating the configuration of a braid fixture according to a first embodiment. More specifically, FIG. 1A is a perspective view illustrating a pair of fixing pieces constituting the fixture, FIG. 1B is a perspective view illustrating a state where a male portion and a female portion provided at ends of the pair of fixing pieces on one side are engaged with each other, and FIG. 1C is a perspective view illustrating a state where flanges provided at ends of the pair of fixing pieces on the other side are matched with each other and are fastened by a screw. Also, FIG. 2 is an exploded perspective view illustrating a case of using the fixture according to the first embodiment to fix an end portion of a braid to a cylindrical portion of a shield shell of a shielded connector.

A fixture 10 according to the first embodiment shown in FIGS. 1A to 1C is for clamping an end portion 6a of a metal cylindrical braid 6 which covers a cylindrical portion 4 of a shield shell 3 of a shielded connector 1, to the cylindrical portion 4 of the shield shell 3 as shown in FIGS. 2A and 2B. The shielded connector 1 is configured to cover the outer side of a connector housing 2 with the metal shield shell 3. The connector housing 2 is made of a resin and accommodates terminals (not shown). The shield shell 3 has the cylindrical portion 4 which can be covered with the end portion 6a of the braid 6 for electrical connection.

Meanwhile, the fixture 10 is formed in a band shape capable of surrounding the outer circumference of the cylindrical portion 4 of the shield shell 3 from on the end portion 6a of the braid 6, and includes a pair of fixing pieces 11, 12 each of which is a half of the fixture. The pair of fixing pieces 11, 12 having halved band shapes have a male portion 13 and a female portion 14 which are provided their ends on one side and can be engaged with and disengaged from each other. In other words, the male portion 13 includes a hook-shaped tongue portion 13a, and the female portion 14 includes an engagement hole 14a with which the tongue portion 13a of the male portion 13 can be engaged. It is possible to hook the tongue portion 13a into the engagement hole 14a, thereby joining the ends of the two fixing pieces 11, 12 on the one side with each other such that they are not separated. In this state, it is possible to open and close the two fixing pieces 11, 12 by using the joining portion of the male portion 13 and the female portion 14 as a hinge.

Also, the other ends of the pair of fixing pieces 11, 12 have flanges 15, 16 which can be matched with each other and be fastened by a screw (a bolt 17 and a nut 18) in that state. The flanges 15, 16 have through-holes 15a, 16a for passing the tip of the bolt 17 respectively.

In a case of using the fixture 10 to fix the braid 6 to the shield shell 3, first, the end portion 6a of the braid 6 is double folded for instance and the outer circumference of the cylindrical portion 4 of the shield shell 3 is covered with the end portion 6a of the braid 6. Next, on the end portion 6a, the fixing pieces 11, 12 of the fixture 10 are matched with each other while the male portion 13 and the female portion 14 provided at the ends on the one side of the fixture 10 are engaged, whereby the end portion 6a of the braid 6 is interposed between the fixing pieces 11, 12 and the cylindrical portion 4 of the shield shell 3.

Next, in that state, the flanges 15, 16 provided at the ends of the pair of fixing pieces 11, 12 on the other side of the fixture 10 are matched with each other, the tip of the bolt 17 is passed through the through-holes 15a, 16a of the both flanges 15, 16, and the nut 18 is tightened onto the tip of the bolt 17, whereby the flanges 15, 16 are fastened. In this way, it is possible to clamp the end portion 6a of the braid 6 onto the outer circumference of the cylindrical portion 4 of the shield shell 3.

According to the braid fixture 10 having the above-mentioned configuration, the pair of fixing pieces 11, 12 are configured as articles each of which is half the fixture, and thus it is possible to assembly the both fixing pieces 11, 12 to the cylindrical portion 4 of the shield shell 3 without deforming anything. Therefore, the clamping force is prevented from being damaged due to deformation of the fixing pieces 11, 12, and thus it is possible to clamp the end portion 6a of the braid 6 onto the cylindrical portion 4 of the shield shell 3 by a sufficient force. Also, since the assembling is completed by fastening the fixing pieces 11, 12 at one position by a screw, it is possible to simply connect the braid 6 to the shield shell 3 with a sufficient clamping force, without increasing not only the number of bolts 17 and nuts 18 but also a man-hour for clamping.

It can also be considered a configuration in which on the ends of the pair of fixing pieces 11, 12 on the one side of the fixture 10 having the male portion 13 and the female portion 14, respectively, flanges similar to those at the ends on the other side are provided instead of the male portion 13 and the female portion 14, and the flanges of the ends of the fixing pieces 11, 12 on both sides are fastened by screws, whereby the end portion 6a of the braid 6 is clamped. However, in this case, the number of bolts 17 and nuts 18 increases, and a man-hour for fastening the bolts 17 and the nuts 18 also increases. In contrast, the fixture 10 of the present embodiment needs only to be fastened at one position on one side by the bolt 17 and the nut 18. Therefore, not only the number of bolts 17 and nuts 18 but also the man-hour for clamping do not increase.

Next, a braid fixture according to a second embodiment will be described.

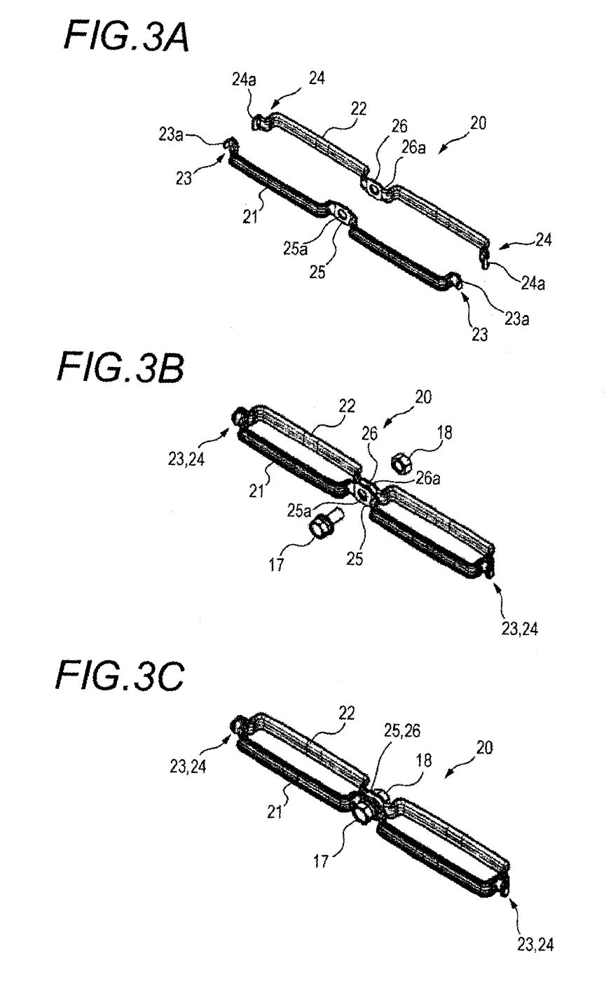

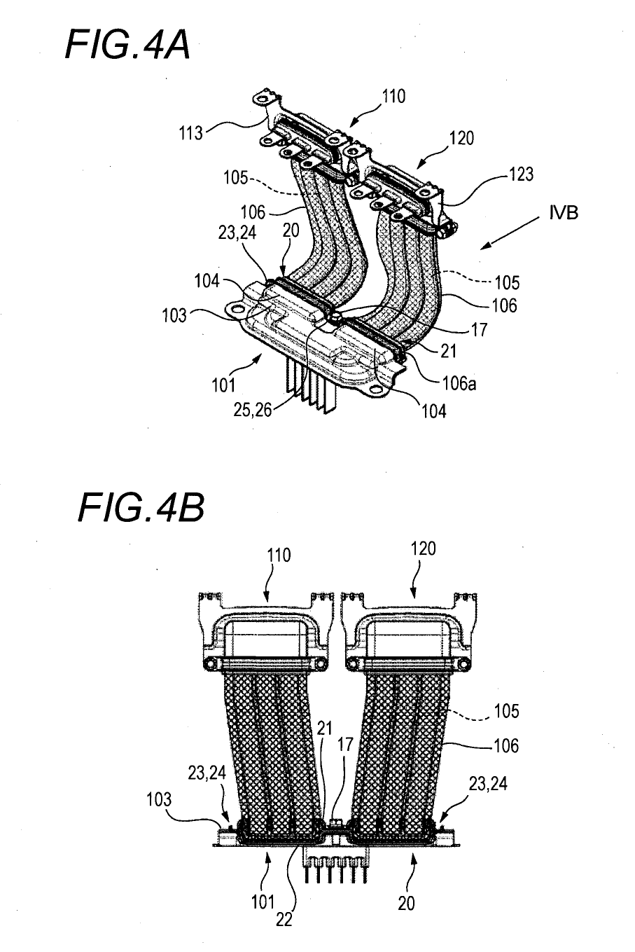

FIGS. 3A to 3C are views illustrating the configuration of a double-barreled fixture of the second embodiment of the present disclosure. More specifically, FIG. 3A is a perspective view illustrating a pair of fixing pieces constituting the fixture, FIG. 3B is a perspective view illustrating a state where male portions and female portions of the pair of fixing pieces on both sides are engaged, and FIG. 3C is a perspective view illustrating a state where flanges of intermediate portions of the pair of fixing pieces are matched with each other and are fastened by a screw. Also, FIG. 4A is a perspective view illustrating a configuration in a case where the fixture of the present embodiment is used to fix end portions of two braids to two cylindrical portions of a shield shell of a shielded connector, and FIG. 4B is a view illustrating the configuration of FIG. 4A as seen in the direction of an arrow IVB.

A fixture 20 of the second embodiment shown in FIGS. 3A to 3C is for clamping end portions 106a of two cylindrical metal braids 106, covering two metal cylindrical portions 104 of a shield shell 103 of a lower shielded connector 101 of a shield connection unit 100, onto the cylindrical portions 104 of the shield shell 103, respectively, at the same time, as shown in FIGS. 4A and 4B.

As shown in FIGS. 4A and 4B, the shield connection unit 100 includes the lower shielded connector 101, two upper shielded connectors 110, 120, two systems of flexible electric wire portions 105 that connect the lower shielded connector 101 and the upper shielded connectors 110, 120, and two braids 106 that surround and shield the two systems of electric wire portions 105, respectively.

The shielded connectors 101, 110, 120 are configured by covering the outer circumferences of connector housings, which are made of a resin and accommodate terminals (all of the connector housings and the terminals are not shown), with metal shield shells 103, 113, 123. The lower shielded connector 101 has two electric wire connection portions which are for connection with the two systems of electric wire portions 105 and are provided to be directed in the same direction and be adjacent to each other, and the electric wire portions have the cylindrical portions 104 of the shield shell 103 for connection with the end portions 106a of the two systems of electric wire portions 105, respectively. The fixture 20 of the present embodiment is used to clamp the end portions of the braids 106 covering the cylindrical portions 104, respectively.

As show in FIGS. 3A to 3C, the fixture 20 is formed in a band shape capable of surrounding the outer circumferences of the two cylindrical portions 104 of the shield shell 103 from on the end portions 106a of the braids 106, respectively, and is composed of a pair of fixing pieces 21, 22 each of which is half of the fixture. The pair of fixing pieces 21, 22 having halved band shapes have male portions 23 and female portions 24 which are provided on both sides and can be engaged with and disengaged from each other. In other words, the male portions 23 include hook-shaped tongue portions 23a, and the female portions 24 include engagement holes 24a. It is possible to hook the tongue portions 23a into the engagement holes 24a, thereby joining the ends of the two fixing pieces 21, 22 on both sides such that they are not separated.

Also, when the pair of fixing pieces 21, 22 of the fixture 20 is assembled, intermediate portions of the pair of fixing pieces 21, 22 are positioned between the two cylindrical portions 104 of the shield shell 103. The intermediate portions have flanges 25, 26 which can be matched with each other and be fastened by a screw (a bolt 17 and a nut 18). At the flanges 25, 26, through-holes 25a, 26a are formed for passing the tip of the bolt 17 through.

In a case of using the fixture 20 to fix the two braids 106 to the two cylindrical portions 104 of the shield shell 103 at the same time, first, the end portions 106a of the braids 106 are double folded for instance, and the outer circumferences of the cylindrical portions 104 of the shield shell 103 are covered with the end portions 106a. Next, from on the end portions 106a, the fixing pieces 21, 22 of the fixture 20 are matched with each other while the male portions 23 and the female portions 24 provided at the ends on both sides are engaged, whereby the end portions 106a of the braids 106 are interposed between the fixing pieces 21, 22 and the cylindrical portions 104 of the shield shell 103.

Next, in that state, the flanges 25, 26 provided at the intermediate portions of the pair of fixing pieces 21, 22 are matched with each other, the tip of the bolt 17 are passed through the through-holes 25a, 26a of the two flanges 25, 26, and the nut 18 is tightened onto the tip of the bolt 17, whereby the flanges 25, 26 are fastened. In this way, it is possible to clamp the end portions 106a of the two braids 106 onto the outer circumferences of the two cylindrical portions 104 of the shield shell 103 at the same time.

According to the braid fixture 20 having the above-mentioned configuration, the pair of fixing pieces 21, 22 are configured as articles each of which is half the fixture, and thus it is possible to assembly the both fixing pieces 21, 22 to the cylindrical portions 104 of the shield shell 103 without deforming anything. Therefore, a clamping force is prevented from being damaged due to deformation of the fixing pieces 21, 22, and thus it is possible to clamp the end portions 106a of the braids 106 onto the cylindrical portions 104 of the shield shell 103 by a sufficient force. Also, since the assembling is completed by fastening the fixing pieces 21, 22 at one position by a screw, it is possible to simply connect the braids 106 to the shield shell 103 with a sufficient force, without increasing not only the number of bolts 17 and nuts 18 but also a man-hour for clamping.

In this connection, it can also be considered a configuration in which even at the ends of the pair of fixing pieces 21, 22 on the both sides having the male portions 23 and the female portions 24, flanges similar to those of the intermediate portions are provided instead of the male portions 23 and the female portions 24, and the flanges provided at the three positions of the fixing pieces 21, 22 are fastened by screws, whereby the end portions 106a of the braids 106 are clamped. However, in this case, the number of bolts 17 and nuts 18 increases, and a man-hour for fastening the bolts 17 and the nuts 18 also increases. In contrast, the fixture 20 of the present embodiment needs only to be fastened at one intermediate position by the bolt 17 and the nut 18. Therefore, not only the number of bolts 17 and nuts 18 but also the man-hour for clamping do not increase.

The present disclosure is not limited to the above-mentioned embodiments, but can be appropriately modified and improved. Further, the material, shape, size, number, disposed position etc. of each of the constituent elements of the above-mentioned embodiments are not limited thereto and may be arbitrary so long as the invention is attained.

For example, in the above-mentioned second embodiment, a case of clamping the end portions 106a of the braids 106 onto the two cylindrical portions 104 of the shield shell 103 at the same time has been described. However, it is possible to clamp end portions 106a of three or more braids 106 onto three or more cylindrical portions 104 of a shield shell 103 at the same time. In this case, the intermediate portions of the pair of fixing pieces 21, 22 need to have flanges which are provided at multiple portions positioned among the cylindrical portions 104 of the shield shell 103 and can be fastened by screws.

The present application is based on Japanese Patent Application No. 2011-256467 filed on Nov. 24, 2011, the contents of which are incorporated herein by reference.

### INDUSTRIAL APPLICABILITY

By the configuration, a braid fixture capable of simply clamping a braid onto a shield shell by a sufficient force, without increasing the number of bolts and nuts and a man-hour for clamping, can be obtained.

### REFERENCE SIGNS LIST

3 shield shell
4 cylindrical portion
6 braid
6a end portion
10 fixture for braid
11, 12 fixing pieces
13 male portion
14 female portion
15, 16 flanges
17 bolt (screw)
18 nut (screw)
103 shield shell
104 cylindrical portion
106 braid
106a end portion
20 fixture for braid
21, 22 fixing pieces
23 male portion
24 female portion
25, 26 flanges

1. A braid fixture for clamping an end portion of a braid, which covers an outer circumference of a cylindrical portion of a shield shell, onto the shield shell, the braid fixture comprising:
a pair of fixing pieces that is formed in a band shape capable of surrounding the outer circumference of the cylindrical portion of the shield shell with the braid which is formed on the outer circumference of the cylindrical portion,
wherein a male portion and a female portion are configured to be engaged with and disengaged from each other, and are provided on one end portions of the pair of fixing pieces respectively; and
wherein flanges are configured to be fastened by a screw, and are provided on the other end portions of the pair of fixing pieces.

2. The braid fixture according to claim 1, wherein the fixing pieces have substantially same shape to each other without the male portion and the female portion.

3. The braid fixture according to claim 1, further comprising:
a pair of other fixing pieces that is formed in a band shape capable of surrounding an outer circumference of a cylindrical portion of other shield shell with a braid which is formed on the outer circumference of the cylindrical portion of the other shield shell,
wherein other male portion and other female portion are configured to be engaged with and disengaged from each other, and are provided on one end portions of the pair of the other fixing pieces respectively;
wherein the other end portions of the pair of the other fixing pieces are connected to the flanges of the fixing pieces respectively; and
wherein the pair of the other fixing pieces clamps an end portion of the braid, which covers the outer circumference of the cylindrical portion of the other shield shell, onto the shield shell.

4. The braid fixture according to claim 3, wherein the other fixing pieces have substantially same shape to each other without the other male portion and the other female portion.
